(19) United States
(12) Patent Application Publication
(10) Pub. No.: US 2015/0231868 A1
(43) Pub. Date: Aug. 20, 2015

(54) METHOD FOR PRESSING OR WELDING THE PROTECTIVE COVER OF A HIGH TEMPERATURE SENSOR

(71) Applicant: TESONA GmbH & Co. KG, Hörselberg/Hainich (DE)

(72) Inventor: Heiko Lantzsch, Eisenach (DE)

(73) Assignee: TESONA GmbH & Co. KG, Hörselberg-Hainich (DE)

(21) Appl. No.: 14/428,900

(22) PCT Filed: Sep. 16, 2013
(86) PCT No.: PCT/EP2013/069158

§ 371 Date: Mar. 17, 2015

(30) Foreign Application Priority Data
Sep. 17, 2012 (DE) 20 2012 103 537.5

(51) Int. Cl. B32B 37/00; G01K 1/08; C03B 23/207

(52) U.S. Cl. CPC B32B 37/0076; C03B 23/207; G01K 1/08; B32B 2315/02

(57) ABSTRACT

The invention relates to a method for producing a protective cover for a high temperature sensor comprising a sensor element, a protective enveloping which at least partially surrounds the sensor element. Said protective cover is secured to the protective enveloping. Also, said protective cover is produced according to a deep-drawing method and/or the protect cover is produced by applying heat with subsequent fusion to at least one side and/or the protective cover is produced by closing the protective enveloping by means of a base stop, in particular by pressing and/or soldering, and/or the protective cover is produced by closing one side according to a shaping method, in particular tumbling, and/or a soldering method and/or said protective cover is secured to the protective tube according to a comparable method. According to the invention, said protective cover is welded and/or pressed to the protective cover.

### CROSS REFERENCE TO RELATED APPLICATIONS

This application claims priority under 35 U.S.C. §119 to PCT Application Number PCT/EP2013/069158 filed Sep. 16, 2013 and which claims priority to German patent document DE 20 2012 103 537.5, the entire contents of which are hereby incorporated by reference herein.

### BACKGROUND

High-temperature sensors are used, for example, to measure the temperature in exhaust pipes of gasoline engines or in furnaces. They may be suited to measure temperatures of greater than 500° C. or more. Especially when used in exhaust pipes in the automobile field, e.g. in exhaust gas cleaning systems, high-temperature sensors of this kind are exposed to high thermal and mechanical (due to the vibrations of the engine) loads. The sensor element for measuring the temperature is, therefore, typically protected by a protective envelope, in particular a protective tube, e.g. of metal.

In particular, high-temperature sensors of this kind may be designed as sheath thermocouples.

DE 10 2008 060 033 A1 discloses a temperature sensor having a thermocouple, which includes a sheathed fireproof cable including a sensor element attached to the cable end facing the sample medium and featuring electric connecting leads that run through a casing tube of the sheathed cable for connecting the sensor element to an electronic evaluation unit. It is proposed to provide a protective sleeve which comprises a one-piece front part, without any welding points. In addition, it is proposed to provide the protective sleeve with a curvature on its front side facing the sample medium.

WO 2010/063682 A1 discloses a temperature sensor having a thermocouple, which includes a sheathed fireproof cable including a sensor element attached to the cable end facing the sample medium. Electric connecting leads run through a metal tube of the sheathed cable for connecting the sensor element to an electronic evaluation unit. The disclosed temperature sensor is to be usable for temperatures up to 1200° C., and capable of sensing fast temperature changes. To this end, the sensor element consists of a thermo wire bead which protrudes from the sheathed cable and is received by a protective envelope that is attached to the end of the sheathed cable facing the sample medium. The protective envelope comprises a one-piece front part, without any welding points, and the sheathed cable is a flexible thin-walled metal tube with a small outer diameter, with the connecting leads running through the section thereof pointing away from the sample medium and creating the desired interface with an on-board electronic system. The attachment of the temperature sensor to the measuring point is realized by a special ring collar and a union nut.

A high-temperature sensor having a sensor element mounted in a protective tube is disclosed in EP 2 196 787 A2. To allow reliable measurements also in high-temperature environments, e.g. the exhaust gas system of a motor vehicle, the protective tube is surrounded by a reinforcement tube, the reinforcement tube is composed of material whose coefficient of thermal expansion is higher than that of the material from which the protective tube is formed. The reinforcement tube is fixedly connected to the protective tube in a first region of the protective tube, and an abutment element is also fixedly connected to the protective tube in a second region of the protective tube. The reinforcement tube, owing to its greater thermal expansion, comes into mechanical contact with the abutment element above a predefined temperature, whereby the high-temperature sensor is mechanically stabilized above this temperature. The space between the sensor element and the protective tube cap of EP 2 196 787 A2 is filled with a material having good heat-conducting properties. In this case, fine silicon powder may be used. The stabilizing mechanical contacting of the protective tube with the abutment element requires a minimum temperature, so that particularly directly in the starting phase, respectively, the non-high-performance operation the overall arrangement tends to vibrate which may put the reliability of the measuring arrangement at risk. The high-temperature sensor can be fixed in the exhaust gas system by means of a mounting pod.

### SUMMARY

The present invention relates to a method for producing a protective cap for a high-temperature sensor comprising a sensor element, a protective envelope surrounding the sensor element at least partially, and a protective cap fixed to the protective envelope, as well as to a high-temperature sensor comprising a sensor element, a protective envelope, in particular a protective tube, surrounding the sensor element at least partially, and a protective cap fixed to the protective envelope, wherein
the protective cap is produced by a deep-drawing process, and/or
the protective cap is produced by the introduction of heat, with subsequent fusion of at least one side, and/or
the protective cap is produced by closing the protective envelope by means of a bottom plug, in particular by pressing and/or welding, and/or
the protective cap is produced by closing one side by a forming process, in particular wobbling, and/or a welding process, and/or
the protective cap is fixed to the protective tube by a comparable method.

The invention also relates to a high-temperature sensor comprising:
a sensor element,
a protective envelope, in particular a protective tube, surrounding the sensor element at least partially, and
a protective cap fixed to the protective envelope, wherein the protective cap is produced in particular according to one of the preceding claims,
   wherein
the protective cap was produced by a deep-drawing process, and/or
the protective cap is produced by the introduction of heat, with subsequent fusion of one side, and/or
the protective cap is a bottom plug pressed or welded to the protective envelope, and/or
the protective cap is realized by closing one side by a forming process, in particular wobbling, and/or a welding process, and/or
the protective cap is fixed to the protective envelope by a comparable method.

It is an object of the invention to provide a further developed method for producing a protective cap for a high-temperature sensor, and a high-temperature sensor comprising such a protective cap, such that the sensor element is protected even under great thermal, chemical and/or mechanical loads and can be manufactured cost-efficiently with little manufacturing expenditure.

In particular, the method is characterized in that the protective cap is welded and/or pressed to the protective envelope.

Thus, it is possible to fix the protective cap to the protective envelope in a particularly reliable manner. In particular, it may be possible to easily fix the protective cap to the protective envelope in a gas-proof manner so that the sensor element is protected against chemical influences.

In an embodiment of the invention it is provided that the pressing, respectively, welding is carried out continuously around the protective envelope. Thus, it is possible to achieve, in particular, a gas-proof encapsulation so that the sensor element is reliably protected against chemical influences.

In another embodiment of the invention it is provided that the pressing, respectively, welding is carried out pointwise around the protective envelope. Conceivable is a partial wobbling of the casing tube of a thermocouple as a sensor, for stabilizing the commonly protruding measuring bead.

In certain pressing or welding processes the pointwise pressing or welding allows an attachment of the protective cap that withstands particularly high mechanical loads.

In another embodiment of the invention it is provided that the welding is realized by a pendulum weld and/or a fillet weld.

Experiments have shown that a combination of these welds makes it possible to realize a particularly gas-proof and stable attachment of the protective cap.

In an embodiment of the invention it is provided that when the protective cap is produced in a deep-drawing process, the protective envelope serves as a drawing punch for the deep-drawing process, wherein in particular the protective envelope is formed as a protective tube from a high-strength material, in particular ceramic, glass ceramic and/or polymer ceramic.

The invention will be explained in more detail below by means of exemplary embodiments and with the aid of figures.

### BRIEF DESCRIPTION OF THE DRAWINGS

In the drawings:

FIG. 1a shows a cross-sectional view of a first high-temperature sensor;

FIG. 1b shows a second cross-sectional view of the high-temperature sensor of FIG. 1a;

FIG. 1c shows a first longitudinal view of the high-temperature sensor of FIG. 1a;

FIG. 1d shows a second longitudinal view of the high-temperature sensor of FIG. 1a;

FIG. 1e shows an enlarged view of a section of FIG. 1c;

FIG. 2a shows a cross-sectional view of a second high-temperature sensor;

FIG. 2b shows a second cross-sectional view of the high-temperature sensor of FIG. 2a;

FIG. 2c shows a first longitudinal view of the high-temperature sensor of FIG. 2a;

FIG. 2d shows a second longitudinal view of the high-temperature sensor of FIG. 2a;

FIG. 2e shows an enlarged view of a section of FIG. 2c;

FIG. 3a shows a cross-sectional view of a third high-temperature;

FIG. 3b shows a second cross-sectional view of the high-temperature sensor of FIG. 3a;

FIG. 3c shows a first longitudinal view of the high-temperature sensor of FIG. 3a;

FIG. 3d shows a second longitudinal view of the high-temperature sensor of FIG. 3a;

FIG. 3e shows an enlarged view of a section of FIG. 3c;

FIG. 4a shows a cross-sectional view of a fourth high-temperature;

FIG. 4b shows a second cross-sectional view of the high-temperature sensor of FIG. 4a;

FIG. 4c shows a first longitudinal view of the high-temperature sensor of FIG. 4a;

FIG. 4d shows a second longitudinal view of the high-temperature sensor of FIG. 4a;

FIG. 4e shows an enlarged view of a section of FIG. 4c;

FIG. 5a shows a cross-sectional view of a fifth high-temperature sensor;

FIG. 5b shows a second cross-sectional view of the high-temperature sensor of FIG. 5a;

FIG. 5c shows a first longitudinal view of the high-temperature sensor of FIG. 5a;

FIG. 5d shows a second longitudinal view of the high-temperature sensor of FIG. 5a;

FIG. 5e shows an enlarged view of a section of FIG. 5c.

FIG. 6a shows a lateral view of a sixth high-temperature sensor;

FIG. 6b shows a longitudinal view of the high-temperature sensor of FIG. 6a;

FIG. 6c shows another longitudinal view of the high-temperature sensor of FIG. 6a;

FIG. 6d shows a top view from the cold side to the high-temperature sensor of FIG. 6a;

FIG. 6e shows a top view from the hot side to the high-temperature sensor of FIG. 6a;

FIG. 6f shows a cross-sectional view of the of the high-temperature sensor of FIG. 6a;

FIG. 6g shows a detailed view of the high-temperature sensor of FIG. 6c;

FIG. 7a shows a lateral view of a seventh high-temperature sensor;

FIG. 7b shows a longitudinal view of the high-temperature sensor of FIG. 7a;

FIG. 7c shows a lateral detailed view of the protective cap of the seventh high-temperature sensor; and

FIG. 7d shows a detailed view of the seventh high-temperature sensor.

### DETAILED DESCRIPTION

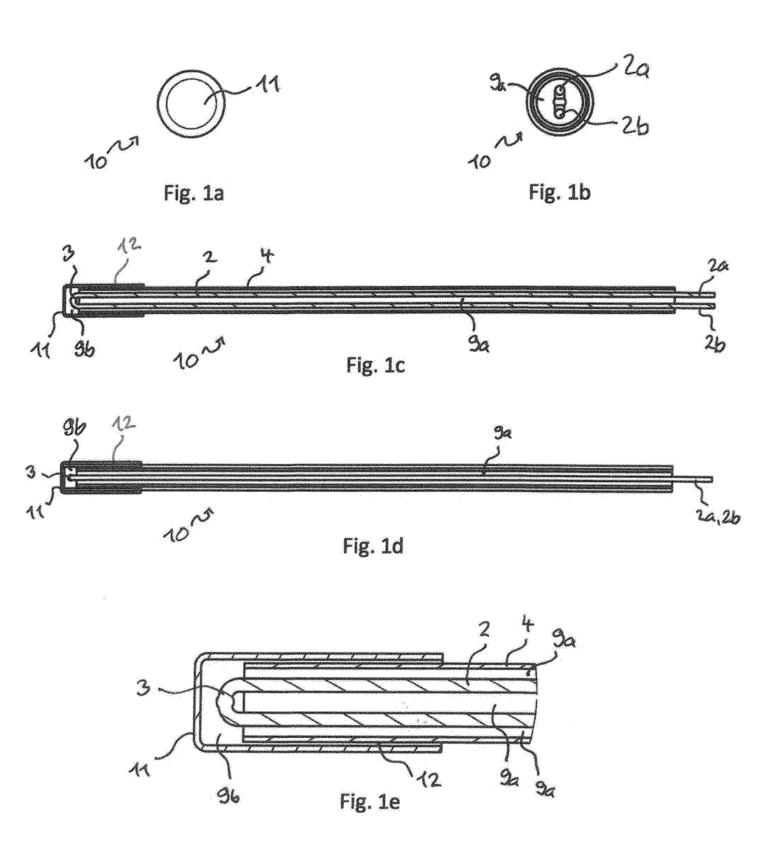

FIGS. 1a to 1d show a first high-temperature sensor 10 whose protective cap 11 was produced by a deep-drawing process and, subsequently, was welded to the protective envelope 4. The high-temperature sensor 10 comprises a longitudinal sensor element 2 with a measuring section 3 arranged on the hot side of the high-temperature sensor 10. Two electrical connections 2a, 2b are located on the cold side.

The sensor element 2 is embedded in a filling material 9a, and is furthermore enclosed by a stable protective envelope 4. However, the measuring section 3 of the sensor element 2 projects out of the protective envelope 4 on the hot side. The measuring section 3 is embedded in a material 9b having good heat-conducting properties, and is covered by the protective cap 11. In the welded portion 12 the protective cap 11 grips over the protective envelope 4.

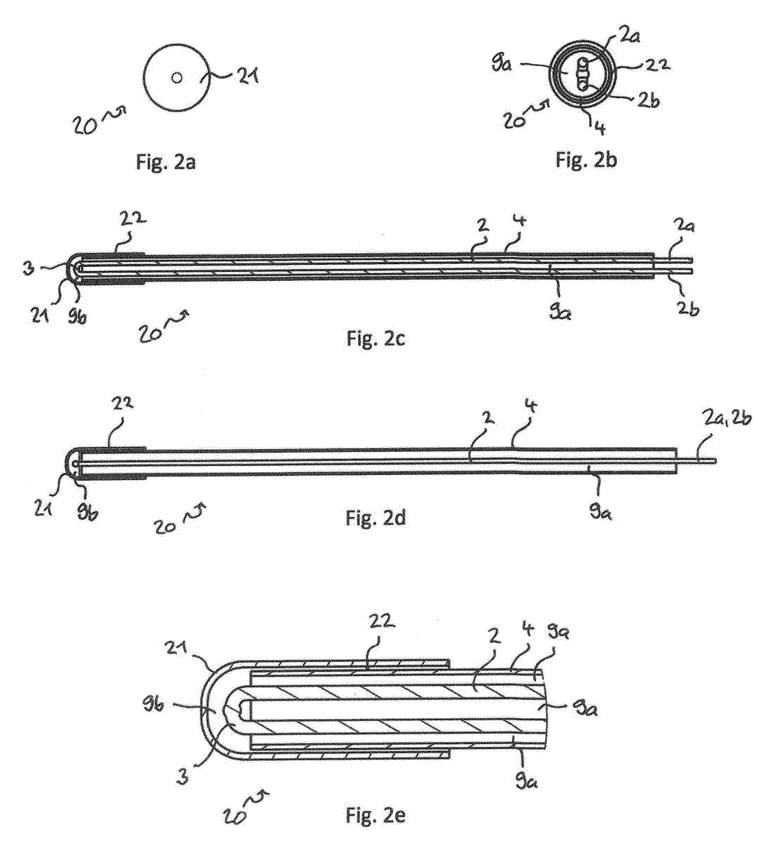

Elements of the high-temperature sensors shown in FIGS. 2a to 5e, which are designated with the same reference numbers used in FIGS. 1a to 1e, assume substantially the same functions as those of the high-temperature sensor shown in FIGS. 1a to 1e.

FIGS. 2a to 2e show lateral and longitudinal views of the high-temperature sensor 20 whose protective cap 21 was produced by the introduction of heat and subsequent fusion of at least one side. Moreover, the protective cap 21 was welded to the protective envelope 4 in section 22.

The fusing together results in a particularly stable, gas-proof closure between the protective cap 21 and the protective envelope 4.

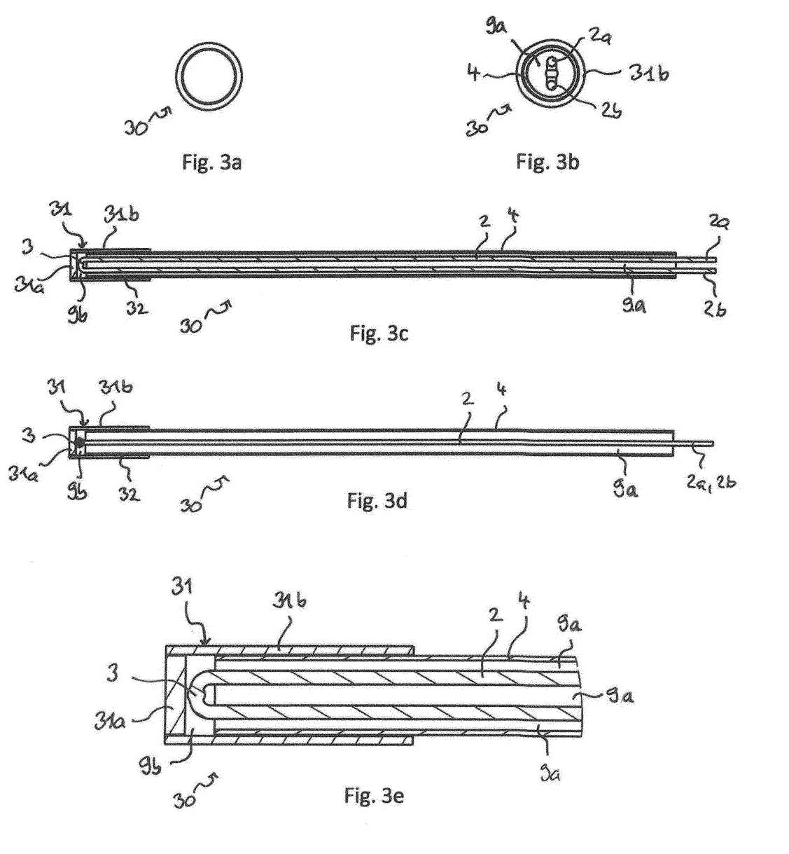

FIGS. 3a to 3e show lateral and longitudinal views of a high-temperature sensor 30 whose protective cap 31 was produced by closing the protective envelope by means of a bottom plug 31, in particular by pressing and/or welding. The bottom plug 31 comprises a hollow-cylindrical section 31b which was pressed together with the protective envelope 4 in a section 32 and welded together subsequently. In other embodiments it is possible that only a pressing or only a welding takes place. The bottom plug 31 furthermore comprises a disc 31a which is located on the hot side of the high-temperature sensor 30.

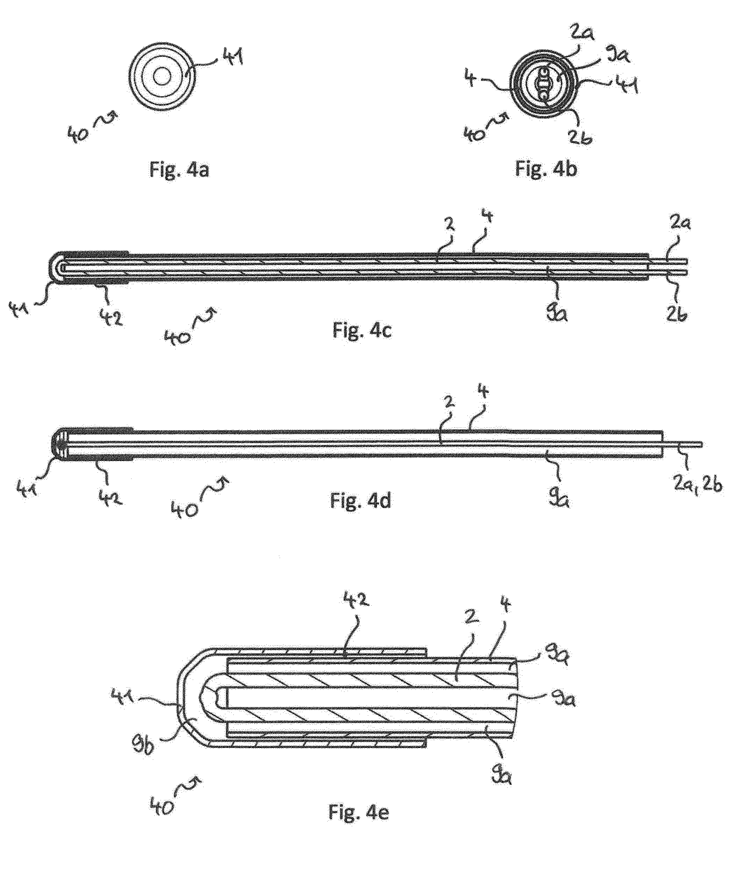

FIGS. 4a to 4e illustrate lateral and longitudinal views of a high-temperature sensor 40 whose protective cap 41 was fixed to the protective envelope 4 by wobbling and welding. The welding was, in this case, carried out in the welding region 42.

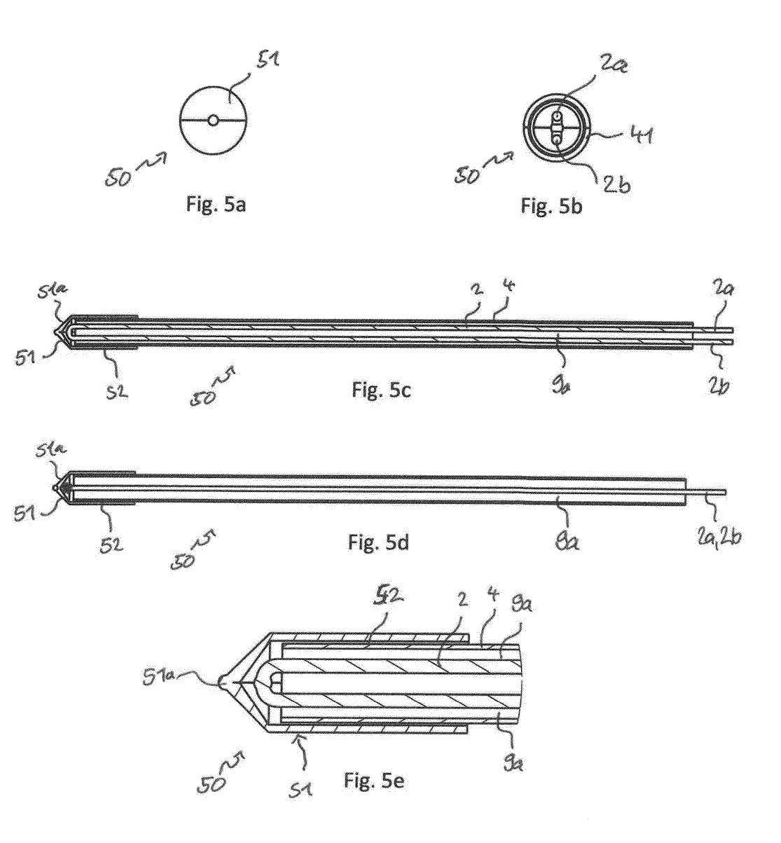

FIGS. 5a to 5e show lateral and longitudinal views of a high-temperature sensor 50 whose protective cap 51 was pressed in a first section 51a, and welded to the protective envelope 4 in a second section 52.

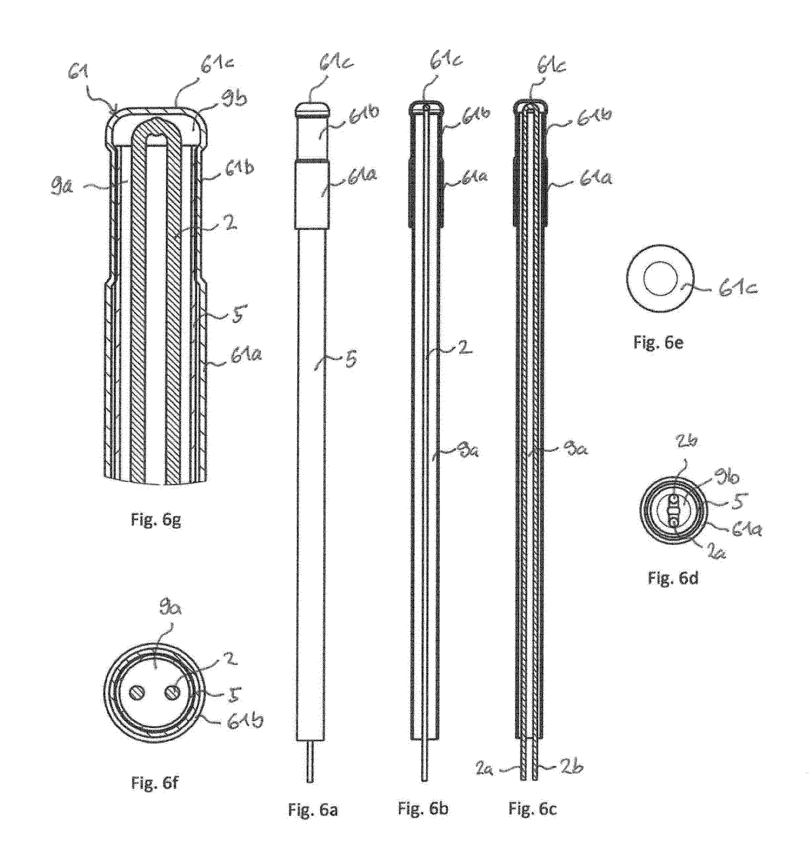

FIGS. 6a to 6g show a high-temperature sensor 60 whose protective cap 61 is welded to the protective tube 5 in a first region 61a, and is pressed to the protective tube 5 in a second region 61b.

FIG. 6a shows a lateral view of the high-temperature sensor 60. The electrical connections 2a, 2b of the protective tube 5 and the protective cap 61 with the first region 61a and the second region 61b are visible. The tip 61c is located above the second region, underneath which tip the measuring section 3 is located and which was neither pressed nor welded.

FIGS. 6b and 6c show cross-sectional views of the high-temperature sensor 60. At the same time, the sensor element 2 and the filling material 9b are illustrated.

FIGS. 6d and 6e show a top view to the high-temperature sensor 60 from the cold, respectively, hot side. In the view from the cold side in FIG. 6d, the two connections 2a, 2b, the filling material 9b, the protective tube 5 and the first region 61a of the protective cap 61 are visible. In the view from the hot side in FIG. 6e the tip 61c of the protective cap 61 is visible.

FIG. 6f shows a cross-sectional view of the high-temperature sensor 60 in the welded region 61a of the protective cap 61, in which the sensor element 2, the filling material 9b, the protective tube 5 and the welded region 61a are visible.

FIG. 6g shows a detailed view of the representation of the protective cap 61 of FIG. 6c. Not visible in this illustration are the welds fixing the protective cap 61 to the protective tube. The measuring section 3 projects over the protective tube 5 and, in the projecting area, is enclosed by a material 9b having good heat-conducting and vibration-damping properties.

In other embodiments the welding in region 61a may even be waived. Experiments have shown that pressing alone across a sufficiently large axial area may allow for sufficient attachment and sealing.

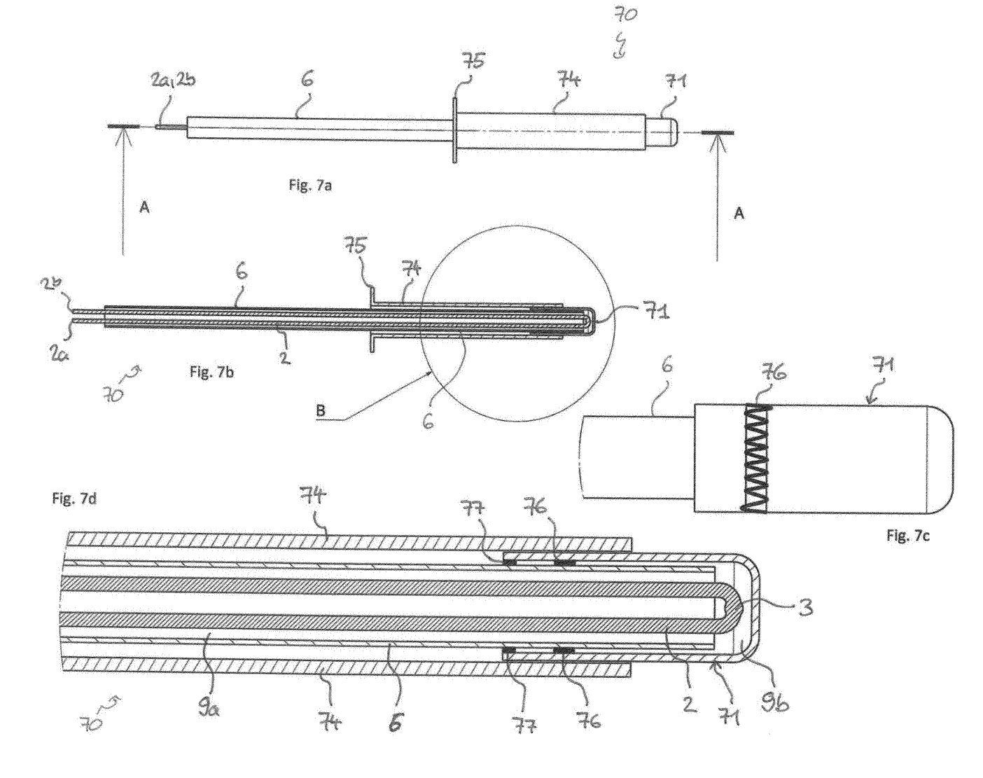

FIG. 7a shows a lateral view of a seventh high-temperature sensor 70, FIG. 7b shows a cross-section through the high-temperature sensor 70 of FIG. 7a. On the cold side the protective tube 6 is visible, on the hot side a support sleeve 74 with a collar 75 is visible. The protective cap 71 is partially arranged inside the support sleeve 74 and partially projects over same.

FIG. 7c shows a detailed lateral view of the protective cap 71 and the protective tube 5. Clearly visible is here the circumferential pendulum weld 76 by means of which the protective cap 71 is welded to the protective tube 5. In this case, the welding was accomplished through the protective cap 71.

FIG. 7d shows a detailed cross-sectional view of the hot side of the high-temperature sensor 70. The sensor element 2 is surrounded, inside the protective tube 5, by a first powdery material 9a, and in the second region which protects over the protective tube 5 by a second powdery material 9b which has good heat-conducting and vibration-damping properties. The protective cap 71 is fixed to the protective tube 5 by the pendulum weld 76 and a fillet weld 77. In particular, the fillet weld serves to seal the high-temperature sensor 70 in gas-proof manner.

The support sleeve 74 covers the two welds 76, 77 and protects them against chemical or mechanical influences which could result in the weld becoming detached or break open.

1. A method for producing a protective cap (11; 21; 31; 41;
51; 61; 71) for a high-temperature sensor (10; 20; 30; 40; 50; 60; 70) comprising a sensor element (2; 3), and a protective envelope (4) surrounding the sensor element (2; 3) at least partially, wherein the protective cap (11; 21; 31; 41; 51; 61; 71) is fixed to the protective envelope (4), and wherein
the protective cap (11) is produced by a deep-drawing process, and/or
the protective cap (21) is produced by the introduction of heat, with subsequent fusion of at least one side of the protective cap (21), and/or
the protective cap (31) is produced by closing the protective envelope (4) by means of a bottom plug (31), by pressing and/or welding, and/or
the protective cap (41) is produced by closing the at least one side by a wobbling and/or a welding process, and/or
the protective cap (11; 21; 31; 41; 51; 61; 71) is welded and/or pressed to the protective envelope (4).

2. The method according to claim 1, characterized in that the pressing, and/or welding is carried out continuously around the protective envelope (4).

3. The method according to claim 1, characterized in that the pressing and/or welding is carried out pointwise around the protective envelope (4).

4. The method according to claim 1, characterized in that the welding is realized by a pendulum weld (76) and/or a fillet weld (77).

5. The method according to claim 1, characterized in that when the protective cap (11) is produced by the deep-drawing process, the protective envelope (4) serves as a drawing punch for the deep-drawing process, wherein the protective envelope (4) is formed from at least one of a ceramic, a glass ceramic and a polymer ceramic.

6. The method according to claim 5, characterized in that a workpiece is thermally conditioned prior to and/or during the performance of the deep-drawing process by means of at least one of a gas burner, electromagnetic radiation, laser light, and inductive heating.

7. The method according to claim 1, characterized in that in the production of the protective cap by the introduction of heat, with the subsequent fusion, first a protective cap blank is placed on the protective envelope (4), and then the protective cap blank is fused by the introduction of heat and thus fixed to the protective envelope (4).

8. The method according to claim 7, characterized in that the introduction of heat is applied by a gas burner and/or by laser light.

9. The method according to claim 7, characterized in that the introduction of heat is accomplished by electric resistance heating by an electric current flowing through the protective cap blank.

10. The method according to claim 1, characterized in that first the introduction of heat is applied to a protective cap blank, and then the protective cap blank is drawn onto the protective envelope (4) in the deep-drawing process.

11. The method according to claim 1, characterized in that in the production of the protective cap (31) by closing the protective envelope (4) with the bottom plug (31), the bottom plug is made of a metal.

12. The method according to claim 1, characterized in that in the production of the protective cap (41) by closing the at least one side by a wobbling and/or a welding process a protective cap blank is first placed on the protective envelope (4), in particular the protective tube (4), and then the protective cap blank is approximated to the contour of the protective envelope (4) or the sensor element (2) by applying a forming force.

13. The method according to claim 1, characterized in that the formed protective cap is subsequently connected to the protective envelope (4) in a non-detachable manner.

14. A high-temperature sensor (10; 20; 30; 40; 50; 60, 70) comprising:
a sensor element (2),
a protective envelope (4) surrounding the sensor element (2) at least partially, and
a protective cap (11; 21; 31; 41; 51; 61; 71) fixed to the protective envelope, wherein
the protective cap (11) is realized by a deep-drawing process, and/or
the protective cap (21) is realized by the introduction of heat, with subsequent fusion of one side of the protective cap (21), and/or
the protective cap (31) is a bottom plug pressed or welded to the protective envelope (4), and/or
the protective cap (41) is realized by closing the one side by a a wobbling and/or a welding process, characterized in that the protective cap (11; 21; 31; 41; 51; 61; 71) is welded and/or pressed to the protective envelope (4).

15. The method according to claim 2, characterized in that the welding is realized by a pendulum weld (76) and/or a fillet weld (77).

16. The method according to claim 3, characterized in that the welding is realized a pendulum weld (76) and/or a fillet weld (77).

17. The method according to claim 2, characterized in that when the protective cap (11) is produced by the deep-drawing process, the protective envelope (4) serves as a drawing punch for the deep-drawing process, wherein the protective envelope (4) is formed from at least one of a ceramic, a glass ceramic and a polymer ceramic.

18. The method according to claim 3, characterized in that when the protective cap (11) is produced by the deep-drawing process, the protective envelope (4) serves as a drawing punch for the deep-drawing process, wherein the protective envelope (4) is formed from at least one of a ceramic, a glass ceramic and a polymer ceramic.

19. The method according to claim 4, characterized in that when the protective cap (11) is produced by the deep-drawing process, the protective envelope (4) serves as a drawing punch for the deep-drawing process, wherein the protective envelope (4) is formed from at least one of a ceramic, a glass ceramic and a polymer ceramic.

20. The method according to claim 2, characterized in that the pressing and/or welding is carried out pointwise around the protective envelope (4).
